(19) United States
(12) Patent Application Publication
(10) Pub. No.: US 2021/0207679 A1
(43) Pub. Date: Jul. 8, 2021

(54) DAMPING FORCE ADJUSTABLE SHOCK ABSORBER

(71) Applicant: HITACHI AUTOMOTIVE SYSTEMS, LTD., Ibaraki (JP)

(72) Inventors: Mikio YAMASHITA, Zama-shi, Kanagawa (JP); Fumiyuki YAMAOKA, Sagamihara-shi, Kanagawa (JP)

(21) Appl. No.: 16/087,345

(22) PCT Filed: Sep. 11, 2017
(86) PCT No.: PCT/JP2017/032637

§ 371 Date: Sep. 21, 2018

(30) Foreign Application Priority Data
Sep. 27, 2016 (JP) 2016-188309

(51) Int. Cl. F16F 9/516; F16F 9/19; F16F 9/348

(52) U.S. Cl. CPC F16F 9/516; F16F 9/19; F16F 9/348; B60G 13/08; F16F 2232/08; F16F 2228/066; F16F 2222/12

(57) ABSTRACT

The invention is so configured that a main valve is disposed under a piston valve, that a sub valve for varying the set load of the main valve is provided in a piston case located above the piston valve, and that a first valve element of the sub valve is slidably sealed onto a case member with a metallic seal only at a single place.

### TECHNICAL FIELD

The invention relates to a damping force adjustable shock absorber including a damping valve mechanism that is installed inside a cylinder.

### BACKGROUND ART

Damping force adjustable shock absorbers include damping valve systems installed inside cylinders. For example, the Patent Literature 1 discloses a damping force adjustable shock absorber in which a needle check valve and a set load variable mechanism for the check valve are installed above a piston.

### CITATION LIST

### Patent Literature

PTL 1: Japanese Unexamined Patent Application Publication (Kokai) No. H11-72133

### SUMMARY OF INVENTION

### Technical Problem

The damping force adjustable shock absorber of the Patent Literature 1 is installed with a valve element in which two metallic seal portions are formed. In order to give the valve element a smooth movement, it is required to enhance accuracy in machining parts, and this has been a cause for production cost increase.

The present invention provides a damping force adjustable shock absorber which enables production cost reduction.

### Solution to Problem

A damping force adjustable shock absorber of the invention comprises a cylinder sealingly containing a hydraulic fluid; a piston slidably fitted in the cylinder to divide an interior of the cylinder into two chambers; a piston rod with one end coupled to the piston and the other end extending outside the cylinder; first and second passages that bring the two chambers in the cylinder into communication; and main and sub valves configured to control hydraulic fluid flows in the first and second passages, which are produced by a sliding movement of the piston in the cylinder, to generate a damping force. The main valve includes a damping valve configured to regulate the flow of the hydraulic fluid flowing through the first passage to generate the damping force when the piston moves to one side, a back pressure chamber configured to apply inner pressure to the damping valve in a valve-closing direction, and a back-pressure-chamber introducing passage configured to introduce the hydraulic fluid from the chamber located upstream to the back pressure chamber side. The sub valve includes a first valve element biased by a biasing device, a second valve element using a portion of the first valve element as a valve seat, and an actuator configured to move the first and second valve elements by using a thrust force of a solenoid. When the piston moves to the one side, the second valve element is opened to adjust pressure in the back pressure chamber. When the piston moves to the other side, the first valve element is opened against the thrust force of the solenoid to bring the second passage into communication.

A damping force adjustable shock absorber of the invention comprises a cylinder sealingly containing a hydraulic fluid; a piston slidably fitted in the cylinder to define an interior of the cylinder into two chambers including a one-side chamber and the other-side chamber; a piston rod with one end coupled to the piston and the other end extending outside the cylinder; first and second passages that bring the two chambers in the cylinder into communication; a first main valve configured to generate a damping force on a fluid flow in the first passage, which is produced when the piston in the cylinder moves to one side; a second main valve configured to generate a damping force on a fluid flow in the second passage, which is produced when the piston in the cylinder moves to the other side; and a sub valve driven by a solenoid and configured to control the damping forces generated when the piston in the cylinder moves to the one side and the other side. The first main valve includes a damping valve configured to regulate a flow of a hydraulic fluid flowing through the first passage to generate a damping force when the piston moves to the one side; a back pressure chamber configured to apply inner pressure to the damping valve in a valve-closing direction; and a back-pressure-chamber introducing passage configured to introduce the hydraulic fluid from the upstream chamber to the back pressure chamber side. The sub valve includes a cylindrical case member inside which a plunger driven by the solenoid is slidably provided, the case member being open at one end; a valve seat member including an annular valve seat provided on an opposite side to the opening, the valve seat being in communication with the one-side chamber at a valve-seat inner peripheral side and in communication with the other-side chamber and the back-pressure-chamber introducing passage at a valve-seat outer peripheral side; a contracted passage provided between the valve-seat outer peripheral side and the other-side chamber; a one-way valve configured to allow the hydraulic fluid to flow from the valve-seat outer peripheral side to the other-side chamber; a first valve element in a bottomed cylindrical shape, which is slidably provided to the case member and configured to be attached to and detached from the valve seat to control the hydraulic fluid flow; and a second valve element seated in an inner valve seat provided between the contracted passage of a bottom portion located inside the case member of the first valve element and the one-side chamber, the second valve element being moved by movement of the plunger.

One embodiment of the invention can reduce the production cost of a damping force adjustable shock absorber.

### BRIEF DESCRIPTION OF DRAWINGS

FIG. 1 is a cross-sectional axial plane view of a damping force adjustable shock absorber according to a first embodiment.

FIG. 2 shows a major part of FIG. 1 in an enlarged scale.

FIG. 3 is an explanatory graph of the first embodiment, which shows results of simulation of damping force characteristics during an expansion stroke, which are obtained when a thrust force of a solenoid is set to have hard, medium, and soft characteristics.

FIG. 4 is an explanatory diagram according to a second embodiment.

### DESCRIPTION OF EMBODIMENTS

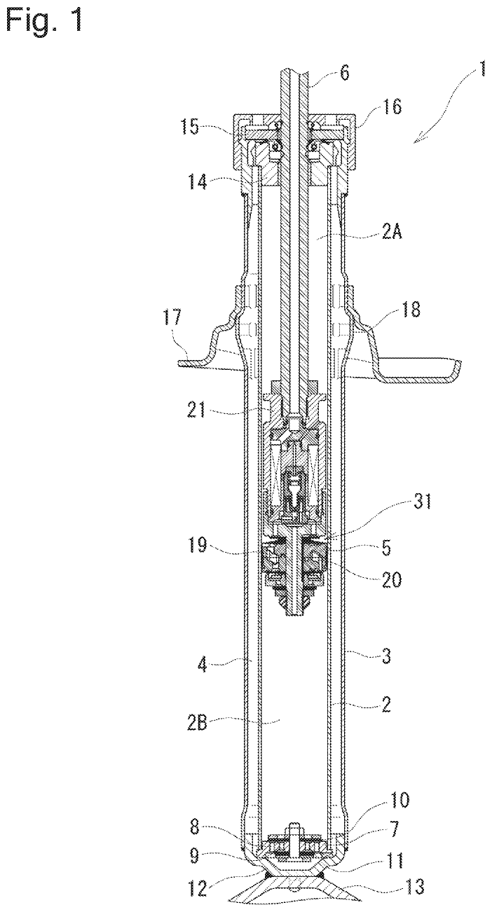

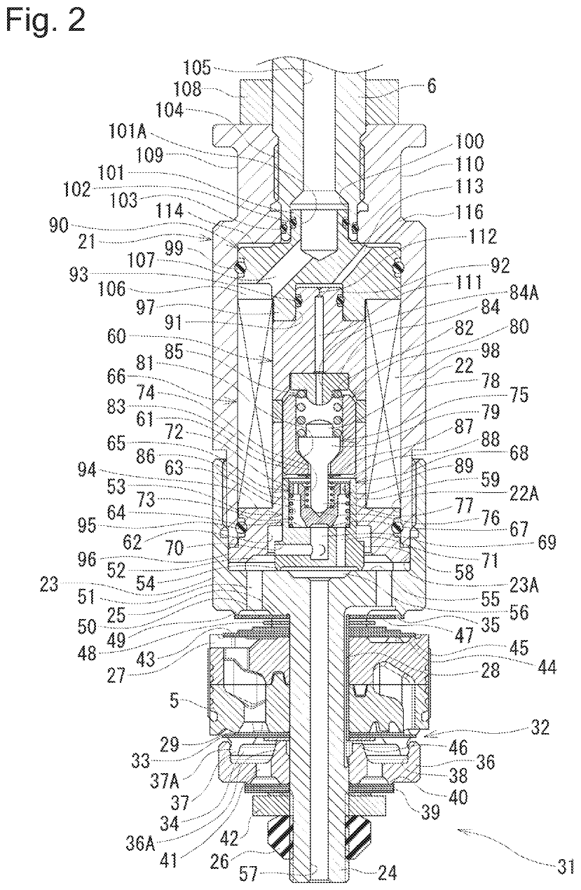

Embodiments of the invention will be described with reference to the attached drawings. For convenience sake, a vertical direction in FIGS. 1 and 2 will be referred to as a vertical direction. (First Embodiment) As illustrated in FIG. 1, a damping force adjustable shock absorber (hereinafter, referred to as a “shock absorber 1”) has a multi-cylinder structure in which an outer tube 3 is provided on an outer side of a cylinder 2. A reservoir 4 is formed between the cylinder 2 and the outer tube 3. A piston valve 5 (piston) is slidably fitted in the cylinder 2. The piston valve 5 divides an interior of the cylinder 2 into two chambers including a cylinder's upper chamber 2A and a cylinder's lower chamber 2B. The piston valve 5 includes an expansion-side passage 19 with an upper end opened into the cylinder's upper chamber 2A, and a compression-side passage 20 with a lower end opened into the cylinder's lower chamber 2B. The piston valve 5 of the first embodiment is a part comprising two divisions arranged in the vertical direction.

In a lower end portion of the cylinder 2, there is provided a base valve 7 that divides the cylinder's lower chamber 2B from the reservoir 4. The base valve 7 is provided with passages 8 and 9 that bring the cylinder's lower chamber 2B and the reservoir 4 into communication. The passage 8 is provided with a check valve 10 that allows oil (hydraulic fluid) only to flow from the reservoir 4 side to the cylinder's lower chamber 2B side. The passage 9 is provided with a disc valve 11 that is opened when pressure of the oil existing on the cylinder's lower chamber 2B side reaches preset pressure, to thereby release the pressure to the reservoir 4 side. The cylinder 2 sealingly contains oil as a hydraulic fluid, whereas the reservoir sealingly contains oil and gas as hydraulic fluids. Referring to FIG. 1, a reference sign 12 represents a bottom cap joined to a lower end of the outer tube 3, and 13 represents an attachment member joined to the bottom cap 12.

The piston valve 5 is coupled to a piston rod 6 with a piston case 21 intervening therebetween. The piston case 21 includes a substantially cylindrical case body 22 to which a lower end (one end) of the piston rod 6 is coupled, a case bottom portion 23 that closes a lower end of the case body 22, and a shaft portion 24 extending downward from the case bottom portion 23 with the piston valve 5 secured thereto. An upper end (the other end) side of the piston rod 6 passes through the cylinder's upper chamber 2A, further extends through a rod guide 14 and an oil seal 15, which are fixed to upper end portions of the cylinder 2 and the outer tube 3, and extends outside the cylinder 2. In this specification, a reference sign 16 in FIG. 1 represents a cap that covers the upper end portion of the outer tube 3. 17 represents a spring retainer attached onto an outer periphery of the outer tube 3, and 18 represents an expanded portion of the outer tube 3, which prevents the spring retainer 17 from moving downward relative to the outer tube 3.

As illustrated in FIG. 2, the shock absorber 1 includes a damping valve mechanism 31 that controls an oil flow between the cylinder's upper chamber 2A and the cylinder's lower chamber 2B, which is produced by movement (expansion and compression) of the piston rod 6. The damping valve mechanism 31 thus generates a damping force. The damping valve mechanism 31 includes a main valve 32 provided to a lower end of the piston valve 5. The main valve 32 includes a damping valve 33 that regulates the oil flow from the cylinder's upper chamber 2A to the cylinder's lower chamber 2B, which is produced when the piston valve 5 moves to an expansion side (one side), to generate the damping force, a back pressure chamber 34 that applies inner pressure to the damping valve 33 in a valve-closing direction, and a back-pressure-chamber introducing passage 35 that introduces the oil from the cylinder's upper chamber 2A to the back pressure chamber 34.

The damping valve 33 comprises a disc valve made of laminated sheets. The damping valve 33 has a shaft hole in the center thereof, and the shaft portion 24 extends through the shaft hole of the damping valve 33. The damping valve 33 has an inner edge portion that is held between an inner peripheral portion of the piston valve 5 and a shaft portion 36A of a pilot case 36. Provided in a lower surface of the damping valve 33 is an annular packing 37. The packing 37 includes a seat portion 37A that slidably contacts an annular recessed portion 38 formed in an upper surface of the pilot case 36. The annular back pressure chamber 34 is thus formed between the damping valve 33 and the pilot case 36. The damping valve 33 is seated in a lower end surface of the piston valve 5 so as to cover a lower end opening of the expansion-side passage 19 that is formed in the piston valve 5. A first passage comprises a notch-shaped passage 27 formed in an upper end of the piston valve 5 and extending in a radial direction, the expansion-side passage 19, and a flow channel that is formed when the damping valve 33 is opened. The first passage brings the cylinder's upper chamber 2A and the cylinder's lower chamber 2B into communication.

The pilot case 36 is provided with a disc valve 39 in a lower end thereof. The pilot case 36 is further provided with a plurality of passages 41 formed through the pilot case 36 in the vertical direction. The disc valve 39 has a shaft hole in the center thereof, and a shaft portion 27 extends through the shaft hole of the disc valve 39. The disc valve 39 is seated in a lower end surface of the pilot case 36 so as to cover a lower end opening of each of the passages 41 of the pilot case 36. When pressure in the back pressure chamber 34 reaches a set load of the disc valve 39, the disc valve 39 is opened, allowing the pressure (oil) to escape to the cylinder's lower chamber 2B. The disc valve 39 has an inner edge portion that is held between the shaft portion 36A of the pilot case 36 and a washer 42.

Provided in the upper end of the piston valve 5 is a disc valve 43. The disc valve 43 has a shaft hole in the center thereof, and the shaft portion 24 extends through the shaft hole of the disc valve 43. The disc valve 43 further includes an inner edge portion that is held between the inner peripheral portion of the piston valve 5 and a presser portion 25 formed in a lower end (lower end of the case bottom portion 23) of the piston case 21. An annular seat portion 45 is formed in the upper end of the piston case 5. The disc valve 43 has an outer edge portion that is seated in the annular seat portion 45 so as to cover the annular recessed portion 44 formed in the upper end of the piston valve 5. Although not illustrated in FIG. 2, the compression-side passage 20 has an upper end that opens into the annular recessed portion 44.

The piston case 21 is provided with a disc valve 47 in the lower end thereof. The disc valve 47 has a shaft hole in the center thereof, and the shaft portion 24 extends through the shaft hole of the disc valve 47. The disc valve 47 has an inner edge portion that is held between a spacer 48 and the presser portion 25 of the piston case 21. The disc valve 47 has an outer edge portion that is seated in an annular seat portion 49 formed in the lower end of the piston case 21. The disc valve 47 thus covers an opening of an annular recessed portion 50 formed in the lower end of the piston case 21. The annular recessed portion 50 communicates with the back pressure chamber 34 via a passage 28 formed in an outer peripheral surface of the shaft portion 24 of the piston case 21 and extending in the vertical direction, and a passage 46 formed in the shaft portion 36A of the pilot case 36. The parts with the shaft holes through which the shaft portion 24 extends, including the piston valve 5, are secured to the lower end of the piston case 5 by axial tension generated by fastening a nut 26 fixed to a lower end portion of the shaft portion 24.

As illustrated in FIG. 2, the case bottom portion 23 is provided with a plurality of (FIG. 2 shows only two) passages 51 formed through the case bottom portion 23 in the vertical direction. Each of the passages 51 has a lower end that is opened into the annular recessed portion 50 located inside the seat portion 49, and an upper end that is opened into a chamber 52 formed in the bottom portion located within the piston case 21. An annular seat portion 54 is formed in a lower end of a first valve element 53. The seat portion 54 is seated in a bottom surface of the piston case 21 (bottom surface of the chamber 52). A recessed portion is formed in a center of the bottom portion of the piston case 21. The seat portion 54 of the first valve element 53 is seated in a valve seat 55 that is formed in an opening edge of the recessed portion, thereby forming a first valve chamber 56 between the first valve element 53 and the case bottom portion 23. The first valve chamber 56 communicates with the cylinder's lower chamber 2B via a passage 57 (axial hole) that vertically extends through a center of the shaft portion 24.

A second passage comprises the passage 57, the first valve chamber 56, a flow channel that is formed when the first valve element 53 is opened, the chamber 52, the passage 51, and a flow channel that is formed when the disc valve 47 is opened. The second passage brings the cylinder's upper chamber 2A and the cylinder's lower chamber 2B into communication. In short, the second passage is brought into communication/disconnection by the opening/closing of the disc valve 47. When the piston valve 5 (piston rod 6) moves to the compression side (the other side), pressure in the first valve chamber 56 reaches a set load, which opens the first valve element 53. The second passage thus brings the cylinder's upper chamber 2A and the cylinder's lower chamber 2B into communication. The chamber 52 communicates with the back pressure chamber 34 via the passage 51, the annular recessed portion 50, and the passage 28.

The first valve element 53 is formed into a stepped column-like shape having a large-diameter portion 58 and a small-diameter portion 59. The small-diameter portion 59 formed in an upper side of first valve element 53 is slidably fitted in a lower portion of a shaft hole 61 of a case member 60. The shaft hole 61 has a lower end that opens into the chamber 52. The first valve element 53 slides against the case member 60 only at a single place (small-diameter portion 59). There is a metallic seal structure between the first valve element 53 and the case member 60.

The case member 60 is provided with a recessed portion 62 that opens into a bottom surface of the case member 60. The recessed portion 62 has an inner diameter that is larger than an outer diameter of the large-diameter portion 58 of the first valve element 53. The lower end of the shaft hole 61 opens into a bottom surface of the recessed portion 62. The chamber 52 is a space enclosed by a portion protruding from the shaft hole 61 of the case member 60 of the first valve element 53, the case bottom portion 23, and the case member 60.

Formed in the first valve element 53 is a bore 63. The bore 63 opens in an upper end of the first valve element 53 (upper end of the small-diameter portion 59). The bore 63 accommodates a second valve element 65 using a bottom surface of the bore 63 (a portion of the first valve element 53) as a valve seat 64. An annular seat portion 67 is seated in the valve seat 64. The annular seat portion 67 is formed in a lower-end edge of the second valve element 65. A set load of the first valve element 53 and that of the second valve element 65 are varied by a thrust force of a solenoid 66. A sub valve 68 includes the first valve element 53, the second valve element 65, and an actuator that moves the first and second valve elements 53 and 65 by using the thrust force of the solenoid 66. Instead of the solenoid 66, for example, a servomotor or the like may be adopted as the actuator.

The first valve element 53 includes a second valve chamber 69 formed of a blind hole that opens in a center of the bottom surface of the bore 63, a passage 70 radially extending in the large-diameter portion 58 to bring the second valve chamber 69 and the chamber 52 into communication, and a passage 71 that brings the second valve chamber 69 into communication with the cylinder's lower chamber 2B when the second valve element 65 is opened. The above-mentioned valve seat 64 is formed in an opening edge of the second valve chamber 69.

The second valve element 65 installed in the first valve element 53 has an upper edge in which a flange 72 is formed. The flange 72 has an outer peripheral surface that slidably contacts an inner peripheral surface of the bore 63. Interposed between the flange 72 and the bottom surface of the bore 63 is a compression spring 73 that biases the second valve element 65 upward against the first valve element 53. The second valve element 65 has a hole 74 that opens in a center of an upper end of the second valve element 65. A conical surface 76 is formed in a center of a bottom portion of the hole 74. The conical surface 76 receives a hemispherical lower end of an actuating pin 75.

The actuating pin 75 includes a shaft portion 77 with a lower end received by the conical surface 76, and a base 79 with a lower part formed into a hemispherical shape. The base 79 is provided with a projection 78 in a center of an upper end thereof. The hemispherical surface of the base 79 of the actuating pin 75 is received by a conical surface 81 formed in a plunger 80 of the solenoid 66. The conical surface 81 is formed in a bottom portion of a hole 82 that opens in an upper end of the plunger 80. The hole 82 communicates with a pin insertion hole 83 that opens in a center of a lower end of the plunger 80. The hemispherical surface of the base 79 of the actuating pin 75 is pressed against the conical surface 81 of the plunger 80 by a compression coil spring 85. The compression coil spring 85 is interposed between the upper end of the base 79 of the actuating pin 75 and a spring retainer 84 fixed to an upper end of the shaft hole 61 of the case member 60.

The first valve element 53 is biased by a biasing force of a biasing device in the downward direction relative to the case member 60 via the second valve element 65 and the actuating pin 75. The thrust force of the solenoid 66 is thus varied, which makes it possible to adjust the set load (valve-opening pressure) of the first valve element 53 when the piston valve 5 (piston rod 6) moves to the compression side (the other side). The biasing device of the first embodiment is the compression coil spring 85.

The second valve element 65 is biased downward relative to the plunger 80 by a compression coil spring 86 fitted onto the shaft portion 77 of the actuator pin 75. The compression spring 86 is compressed between a washer 87 and the bottom surface of the bore 63. The shaft portion 77 of the actuator pin 75 extends through the washer 87, and the washer 87 is fixed to the lower end of the plunger 80. The plunger 80 is slidably fitted together with the shaft hole 61 of the case member 60, namely, the small-diameter portion 59 of the first valve element 53. A space 88 is formed between the plunger 80 located within the shaft hole 61 of the case member 60 and the second valve element 65. The space 88 communicates with the bore 63 via a passage 89 formed in the flange 72 of the second valve element 65.

The case member 60 includes a small-diameter portion 92 formed in an upper end side thereof and a larger-diameter portion 94 formed in a lower end side thereof. The small-diameter portion 92 is fitted in a recessed portion 91 that opens in a center of a lower end of a coil cap 90. A gap between the recessed portion 91 and the small-diameter portion 92 is sealed with an O-ring 93 fixed to the small-diameter portion 92. The large-diameter portion 94 is fitted in an inner peripheral surface 21A of the piston case 21. A gap between the inner peripheral surface 21A of the piston case 21 and the large-diameter portion 94 is sealed with an O-ring 95 fixed to the large-diameter portion 94. Formed in a lower end of the large-diameter portion 94 is a flange 96 that is fitted in an inner peripheral surface of the case bottom portion 23. The lower end of the case body 22 is placed against the flange 96.

The coil cap 90 is fitted in an upper end part of the inner peripheral surface 22A of the case body 22. A gap between the inner peripheral surface 22A and the coil cap 90 is sealed with an O-ring 99 fixed to the coil cap 90. A boss portion 97 is formed in the lower end of the coil cap 90. The above-mentioned recessed portion 91 is formed by a shaft hole of the boss portion 97. The boss portion 97 of the coil cap 90 is inserted into a coil 98 of the solenoid 66 from an upper end of the coil 98, and the case member 60 is inserted into the coil 98 of the solenoid 66 from a lower end of the coil 98. The coil 98 is inserted in the case body 22. The coil 98 is vertically supported between the coil cap 90 and the large-diameter portion 94 of the case member 60.

A cylindrical portion 101 is formed in a center of an upper end of the coil cap 90. The cylindrical portion 101 is fitted in a recessed portion 100 that opens in a lower end of the piston rod 6. A gap between the recessed portion 100 of the piston rod 6 and the cylindrical portion 101 of the coil cap 90 is sealed with an O-ring 102 fixed to the cylindrical portion 101. A gap between the piston rod 6 and the case body 22 is sealed with an O-ring 103 fixed to the lower end of the piston rod 6.

The piston rod 6 and the case body 22 are coupled together by means of a screw 104. A shaft hole 105 of the piston rod 6 communicates with the coil 98 via a shaft hole 101A of the cylindrical portion 101 of the coil cap 90, a notch-shaped passage 106 radially extending in the lower end of the coil cap 90, and a passage 107 that brings the shaft hole 101A and the passage 106 into communication. A cable for supplying electric power to the coil 98 extends through the shaft hole 105 of the piston rod 6. In this specification, a reference sign 108 in FIG. 2 represents a stopper fitted onto the piston rod 6 and provided to the upper end of the piston case 21, and reference signs 109 and 110 represent double chamfered portions for tool engagement at the time of assembly.

The hole 82 of the plunger 80 communicates with the cylinder's upper chamber 2A via a shaft hole 84A of the spring retainer 84, a passage 111 extending along a center line of the case member 60, an orifice 112 formed in an upper end of the passage 111, a chamber 113 formed between the recessed portion 91 of the coil cap 90 and an upper end of the small-diameter portion 92 of the case member 60, an annular passage 114 formed between an upper outer edge of the coil cap 90 and the case body 22 of the piston case 21, a passage 115 formed in the coil cap 90 to bring the chamber 113 and the passage 114 into communication, and a passage 116 formed in the case member 22. This forms a passage for removing the air that remains in the piston case 21 after assembly.

The following description will explain operation of the first embodiment.

When vibration occurs in a vehicle where a shock absorber 1 is placed between sprung mass and un-sprung mass of a suspension system, the piston rod 6 of the shock absorber 1 expands out of and retracts into the outer tube 3. This generates a damping force in the damping valve mechanism 31 and absorbs the vibration of the vehicle. During an expansion stroke of the piston rod 6 (hereinafter, referred to as “during the expansion stroke”), the damping valve mechanism 31 adjusts the damping force by varying the back pressure of the main valve 32 (pressure of the back pressure chamber 34) to change the valve-opening pressure of the damping valve 33. During a compression stroke of the piston stroke 6 (hereinafter, referred to as “during the compression stroke”), the damping valve mechanism 31 adjusts the damping force by controlling the thrust force of the solenoid 66 to change the set load (valve-opening pressure) of the first valve element 53.

During the expansion stroke, the oil (hydraulic fluid) existing on the cylinder's upper chamber 2A side is pressurized due to the movement of the piston valve 5 (piston) in the cylinder 2. When the second valve element 65 is closed, that is, when the seat portion 67 of the second valve element 65 is seated in the valve seat 64 formed in a portion of the first valve element 53, an upstream side of the back pressure chamber 34 communicates with the cylinder's upper chamber 2A via the passage 46, the passage 28, the annular recessed portion 50, and the back-pressure-chamber introducing passage 35 formed in the disc valve 47. The pressurized oil on the cylinder's upper chamber 2A side is accordingly introduced into the back pressure chamber 34 via the back-pressure-chamber introducing passage 35, the annular recessed portion 50, the passage 28, and the passage 46.

A downstream side of the back pressure chamber 34 communicates with the second valve chamber 69 via the passage 46, the passage 28, the annular recessed portion 50, the passage 51, the chamber 52, and the passage 70. This makes it possible to vary the pressure of the back pressure chamber 34, that is, the back pressure of the main valve 32 by controlling the thrust force (control current) of the solenoid 66, to thereby adjust the set load (valve-opening pressure) of the damping valve 33. At this timing, if the pressure in the second valve chamber 69 reaches the set load of the second valve element 65, and the second valve element 65 is opened, the second valve chamber 69 in communication with the back pressure chamber 34 communicates with the cylinder's lower chamber 2B via the passage 71 that is formed in the first valve element 53, the first valve chamber 56, and the passage 57.

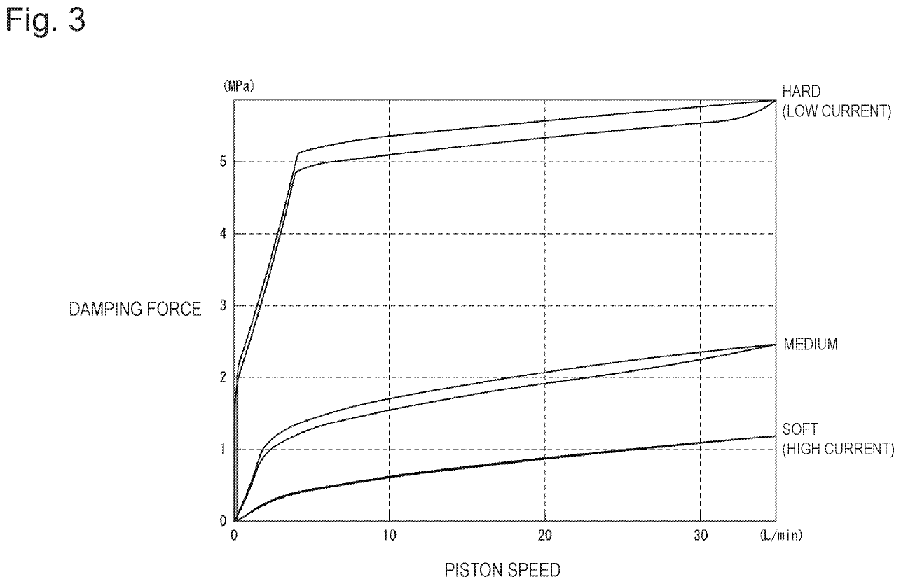

Before the main valve 32 is opened, it is possible to obtain a damping force with orifice characteristics, which is generated by the oil passing through an orifice 29 formed in the damping valve 33 via the passage 28 and the expansion-side passage 19. After the main valve 32 is opened, it is possible to obtain a damping force with valve characteristics of the damping valve 33, which is generated by the oil flowing through the first passage. An amount of oil, which is equivalent to the amount by which the piston rod 6 comes out of the cylinder 2, flows from the reservoir 4, opens the check valve 10 of the base valve 7, and enters the cylinder's lower chamber 2B. During the expansion stroke, the first valve element 53 is not opened since the first valve chamber 56 is in communication with the cylinder's lower chamber 2B via the passage 57. FIG. 3 shows simulation results obtained by analyzer. A graph of FIG. 3 shows curves indicative of damping force characteristics during the expansion stroke, which are obtained when the thrust force of the solenoid 66 is set to have hard (low control current), medium (medium control current), and soft (high control current) characteristics.

During the compression stroke, the oil (hydraulic fluid) existing on the cylinder's lower chamber 2B side is pressurized due to movement of the piston valve 5 (piston) in the cylinder 2. The oil on the cylinder's lower chamber 2B side therefore passes through the compression-side passage 20 to open the disc valve 43. The oil thus brings the second passage into communication and flows to the cylinder's upper chamber 2A. This makes it possible to obtain the damping force with the valve characteristics, which is generated by the disc valve 43. The amount of oil, which is equivalent to the amount by which the piston rod 6 enters the cylinder 2, flows to the reservoir 4 when the pressure in the cylinder's lower chamber 2B reaches a valve-opening pressure of the disc valve 11 of the base valve 7 to open the disc valve 11.

In parallel to the foregoing process, during the compression stroke, the thrust force (control current) of the solenoid 66 is controlled to vary the set load (valve-opening pressure) of the first valve element 53. In other words, the first valve element 53 is opened against the controlled thrust force of the solenoid 66. The opening of the first valve element 53 causes the oil existing on the cylinder's lower chamber 2B side to pass through the passage 57, the chamber 52, the passage 51, and the annular recessed portion 50. The oil then opens the disc valve 47 in which the back-pressure-chamber introducing passage 35 is formed. The oil further flows to the cylinder's upper chamber 2A. As the result, it is possible to obtain the damping force with the valve characteristics, which is generated by the disc valve 47. The first valve element 53 and the second valve element 65 move integrally with each other during the compression stroke.

The following description will explain operation and advantageous effects of the first embodiment.

As described in the Patent Literature 1, if a valve element is provided with two metallic seal portions, it is required, in order to give the valve element a smooth movement, to enhance accuracy in processing the valve element and a damping piston installed with the valve element, that is, accuracy in surface roughness and surface shape, and also enhance a coaxiality degree between the two metallic seal portions. This incurs an increase in cost of producing the damping force adjustable shock absorber.

Unlike the Patent Literature 1, the first embodiment is so configured that the main valve 32 is disposed under the piston valve 5 (piston), and that the sub valve 68 for varying the set load of the main valve 32 is provided inside the piston case 21 located above the piston valve 5. Instead of sealing the first valve element 53 of the sub valve 68 onto the case member 60 with metallic seals at a plurality of places, the first valve element 53 is slidably sealed with a metallic seal only at a single place. This enables the sub valve 68 to be reduced in part accuracy. It is therefore possible to ensure performance equivalent to that of a conventional damping force adjustable shock absorber in which a damping valve mechanism is installed inside a cylinder. It is also possible to achieve production cost reduction and productivity improvement.

The first embodiment adopts a so-called packing valve as the main valve 32, in which the seat portion 37A of the packing 37 secured to the damping valve 33 slidably contacts the annular recessed portion 38 of the pilot case 36. This facilitates design and production, making it possible to reduce the production cost and ensure reliability.

According to conventional art, if a main valve is configured to be variable in back pressure, orifices are formed in the parts designed by type, so that production cost increase has been inevitable. According to the first embodiment, since the back-pressure-chamber introducing passage 35 is formed in the disc valve 47, there is no need to produce the parts by type in which orifices are formed. This represses the production cost increase. The first embodiment further makes it possible to cause the disc valve 47 in which the back-pressure-chamber introducing passage 35 is formed to function as a check valve for generating the damping force during the compression stroke.

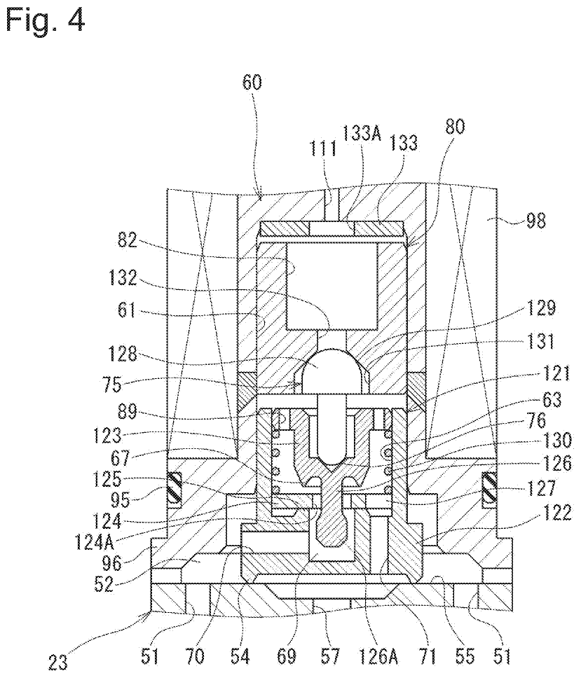

(Second Embodiment) A second embodiment will be now explained with reference to FIG. 4. Constituent elements similar or corresponding to those of the first embodiment will be provided with similar names and reference signs, and detailed descriptions thereof will be omitted.

The first embodiment uses the sub valve 68 of a so-called normally-closed type in which, when the thrust force of the solenoid 66 reaches zero (control current 0), the biasing force of the compression coil spring 85 (biasing device) causes the second valve element 65 to be seated in the valve seat 64 formed in the first valve element 53. The second embodiment uses a sub valve 121 of a so-called normally-open type. When a thrust force of a solenoid 66 reaches zero, a second valve element 123 moves upward relative to a first valve element 122 to be detached from a valve seat member 124 due to a biasing force of a compression coil spring 130 (biasing device).

The sub valve 121 includes the first valve element 122 and the second valve element 123 accommodated in a bore 63 of the first valve element 122. As with the first embodiment, the first valve element 122 is formed into a stepped column-like shape including a large-diameter portion 58 and a small-diameter portion 59. The small-diameter portion 59 located on an upper side is slidably fitted in a shaft hole 61 of a case member 60. The first valve element 122 slides against the case member 60 only at a single place (small-diameter portion 59). A metallic seal structure is formed between the first valve element 122 and the case member 60. The first valve element 122 is biased downward against a second valve element 65 by the compression coil spring 130 (biasing device of the second embodiment) that is interposed between a flange 72 and the valve seat member 124 described later.

The second valve element 123 is seated in the valve seat member 124 provided in a bottom portion of the bore 63 of the first valve element 122. The valve seat member 124 has an outer peripheral surface formed into a ring-like shape that slidably contacts the bore 63. The valve seat member 124 further has an inner edge portion that is supported by an annular protruding portion 125 formed in an opening edge of a second valve chamber 69. A seat portion 67 of the second valve element 123 is seated in the inner edge portion of the valve seat member 124. In other words, the second valve element 123 is seated in (a portion of) the annular protruding portion 125 of the first valve element 122 with the valve seat member 124 intervening therebetween.

The second valve element 123 includes a shaft portion 126 extending downward through a shaft hole 124A of the valve seat member 124. The shaft portion 126 is provided with a lower end portion 126A having an outer diameter that is larger than an outer diameter of the shaft portion 126 and smaller than an inner diameter of the shaft portion 124A of the valve seat member 124. The lower end portion 126A is located in the second valve chamber 69 when the second valve element 123 is closed. When the second valve element 123 is opened, that is, when the annular seat portion 67 is detached from the valve seat member 124, the second valve chamber 69 comes into communication with the first valve chamber 56 via a notch-shaped passage 127 formed in the valve seat member 124.

An actuating pin 75 has a hemispherical lower end that is received by a conical surface 76 formed in a center of a bottom portion of a hole 74 of the second valve element 65. The actuating pin 75 includes a head portion 128 with an upper end in which a hemispherical surface is formed. The hemispherical surface is received by a conical surface 129 formed in a plunger 80 of the solenoid 66. The conical surface 81 of the first embodiment and the conical surface 129 of the second embodiment face in vertically opposite directions. The plunger 80 has an opening 131 in a lower end thereof. The opening 131 communicates with a hole 82 that opens in the upper end of the plunger 80 through a passage 132. The hole 82 communicates with a passage 111 extending along a center line of the case member 60 through a shaft hole 133A of an annular member 133 provided in an upper end of the shaft hole 61 of the case member 60.

The following description will explain operation and advantageous effects of the second embodiment.

According to the second embodiment, the movement of the main valve 32 and the sub valve 121 during the expansion and compression strokes are similar to the movement of the main valve 32 and the sub valve 68 in the first embodiment. The second embodiment therefore provides the operation and advantageous effects equivalent to those of the first embodiment.

According to the second embodiment, for example, when the thrust force of the solenoid 66 reaches zero because of a failure in an electric system, a spring force of the compression coil spring 130 (biasing force of the biasing device) causes the second valve element 123 to move upward relative to the first valve element 122, to thereby place the lower end portion 126A of the shaft portion 126 of the second valve element 123 into the shaft hole 124A of the valve seat member 124. This forms a passage whose flow channel is limited between the lower end portion 126A of the shaft portion 126 of the second valve element 123 and the shaft hole 124A of the valve seat member 124. This passage makes it possible to obtain a damping force with medium characteristic when a failure occurs. The passage can be adjusted in opening area in accordance with a size of the shaft hole 124A of the valve seat member 124. It is therefore possible to carry out the tuning for achieving a desired damping force characteristic in the event of a failure simply by replacing the valve seat member 124. This improves tunability.

The invention is not limited to the foregoing embodiments but includes various modified examples. For example, the embodiments have been discussed in details just for comprehensive explanation of the invention and therefore do not necessarily have to include all the configurations described above. The configuration of one of the embodiments may be partially replaced with that of another embodiment. The configuration of one of the embodiments may be incorporated with that of another embodiment. It is also possible to add, cancel or replace the configuration of one of the embodiments to, from or with that of another embodiment.

The present application claims priority under Japanese Patent Application No. 2016-188309 filed on Sep. 27, 2016. The entire disclosure of Japanese Patent Application No. 2016-188309 filed on Sep. 27, 2016, including the description, claims, drawings and abstract, is incorporated herein by reference in its entirety.

### REFERENCE SIGN LIST

1: Damping force adjustable shock absorber
2: Cylinder
2A: Cylinder's upper chamber
2B: Cylinder's lower chamber
5: Piston valve (piston)
6: Piston rod
32: Main valve
33: Damping valve
34: Back pressure chamber
35: Back-pressure-chamber introducing passage
53: First valve element
64: Valve seat
65: Second valve element
66: Solenoid
68: Sub valve
73: Compression coil spring (biasing device)
75: Actuating pin

1. A damping force adjustable shock absorber comprising:
a cylinder sealingly containing a hydraulic fluid;
a piston slidably fitted in the cylinder to divide an interior of the cylinder into two chambers;
a piston rod with one end coupled to the piston and the other end that extends outside the cylinder;
first and second passages that bring the two chambers in the cylinder into communication; and
main and sub valves configured to control hydraulic fluid flows in the first and second passages, which are produced by a sliding movement of the piston in the cylinder, to generate a damping force,
wherein the main valve includes a damping valve configured to regulate the flow of the hydraulic fluid flowing through the first passage to generate the damping force when the piston moves to one side, a back pressure chamber configured to apply inner pressure to the damping valve in a valve-closing direction, and a back-pressure-chamber introducing passage configured to introduce the hydraulic fluid from the chamber located upstream to the back pressure chamber side;
wherein the sub valve includes a first valve element biased by a biasing device, a second valve element using a portion of the first valve element as a valve seat, and an actuator configured to move the first and second valve elements by using a thrust force of a solenoid; and
wherein the second valve element is opened to adjust pressure in the back pressure chamber when the piston moves to the one side, and the first valve element is opened against the thrust force of the solenoid to bring the second passage into communication when the piston moves to the other side.

2. The damping force adjustable shock absorber according to claim 1,
wherein the second valve element is a normally-open valve.

3. The damping force adjustable shock absorber according to claim 1,
wherein the second valve element is a normally-closed valve.

4. The damping force adjustable shock absorber according to claim 1,
wherein the sub valve forms an introduction orifice when the piston moves to the one side; and
wherein the introduction orifice comprises a disc valve.

5. The damping force adjustable shock absorber according to claim 4,
wherein the disc valve functions as a valve element for opening/closing the second passage when the piston moves to the other side.

6. A damping force adjustable shock absorber, comprising:
a cylinder sealingly containing a hydraulic fluid;
a piston slidably fitted in the cylinder to define an interior of the cylinder into two chambers including a one-side chamber and the other-side chamber;
a piston rod with one end coupled to the piston and the other end that extends outside the cylinder;
first and second passages that bring the two chambers in the cylinder into communication;
a first main valve configured to generate a damping force on a fluid flow in the first passage, which is produced when the piston in the cylinder moves to one side;
a second main valve configured to generate a damping force on a fluid flow in the second passage, which is produced when the piston in the cylinder moves to the other side; and
a sub valve driven by a solenoid and configured to control the damping forces generated when the piston in the cylinder moves to the one side and the other side,
wherein the first main valve includes a damping valve configured to regulate a flow of a hydraulic fluid flowing through the first passage to generate a damping force when the piston moves to the one side, a back pressure chamber configured to apply inner pressure to the damping valve in a valve-closing direction, and a back-pressure-chamber introducing passage configured to introduce the hydraulic fluid from the upstream chamber to the back pressure chamber side; and
wherein the sub valve includes:
a cylindrical case member inside which a plunger driven by the solenoid is slidably provided, the cylindrical case member being open at one end;
a valve seat member including an annular valve seat provided on an opposite side to the opening, the valve seat being in communication with the one-side chamber at a valve-seat inner peripheral side and in communication with the other-side chamber and the back-pressure-chamber introducing passage at a valve-seat outer peripheral side;
a contracted passage provided between the valve-seat outer peripheral side and the other-side chamber;
a one-way valve configured to allow the hydraulic fluid to flow from the valve-seat outer peripheral side to the other-side chamber;
a first valve element in a bottomed cylindrical shape, which is slidably provided to the case member and configured to be attached to and detached from the valve seat to control the hydraulic fluid flow; and
a second valve element seated in an inner valve seat provided between the contracted passage of a bottom portion located inside the case member of the first valve element and the one-side chamber, the second valve element being moved by movement of the plunger.

7. The damping force adjustable shock absorber according to claim 2,
wherein the sub valve forms an introduction orifice when the piston moves to the one side; and
wherein the introduction orifice comprises a disc valve.

8. The damping force adjustable shock absorber according to claim 3,
wherein the sub valve forms an introduction orifice when the piston moves to the one side; and
wherein the introduction orifice comprises a disc valve.
